(19) United States
(12) Patent Application Publication
(10) Pub. No.: US 2026/0218544 A1
(43) Pub. Date: Jul. 30, 2026

(54) Motor Vehicle Closure Device and Method for Actuating the Same

(71) Applicant: Bayerische Motoren Werke Aktiengesellschaft, Muenchen (DE)

(72) Inventors: Jonathan Roth, Muenchen (DE); Daniel Kuelzer, Muenchen (DE)

(21) Appl. No.: 19/145,063

(22) PCT Filed: Oct. 4, 2023
(86) PCT No.: PCT/EP2023/077384

§ 371 Date: Jul. 1, 2025

(30) Foreign Application Priority Data
Jan. 9, 2023 (DE) 10 2023 100 268.6

(51) Int. Cl. E05B 77/54; B60K 15/05; E05F 15/73

(52) U.S. Cl. CPC E05B 77/54; B60K 15/05; E05F 15/73; B60K 2015/0538; E05Y 2900/534

(57) ABSTRACT

A method for actuating a motor vehicle closure of a motor vehicle is disclosed herein. The method includes detecting a current first position of the motor vehicle with a position sensor of the motor vehicle. Additionally, the method includes determining a distance of the motor vehicle from a power source for the motor vehicle for filling an energy storage device of the motor vehicle, and determining a second position of a mobile access authorization device from the motor vehicle for a person with a further position detection sensor of the access authorization device. When the motor vehicle is within a predetermined first distance threshold from the power source and when the second position is within a second predetermined distance threshold from the motor vehicle closure, and when a removal of a filling nozzle is determined, then the motor vehicle closure is actuated with a computer of the motor vehicle closure.

### CROSS-REFERENCE TO RELATED APPLICATIONS

The present application is the U.S. national phase of PCT Application PCT/EP2023/077384 filed on Oct. 4, 2023, which claims priority to German patent application No. 10 2023 100 268.6 filed on Jan. 9, 2023, the entire contents of which are incorporated by reference herein.

### FIELD

The present disclosure relates to the field of motor vehicles, and particularly to motor vehicle closure devices and methods for actuating a motor vehicle closure devices.

### BACKGROUND

It is already known from the prior art that motor vehicle closures, such as fuel filler caps or charging covers, can be opened suitably automatically or mechanically, for example to gain access for a filling nozzle. Especially at filling stations or charging stations, a suitable nozzle can then be inserted into an opening, for example to refuel electrical energy or fluidic fuel into the vehicle. Corresponding mechanical closure devices are already known for this purpose, which, for example, allow the cap to pop open in order to be able to achieve easy access. However, it is always necessary for the person to operate the fuel filler cap accordingly. For example, in the case of a dirty vehicle, this can lead to the person getting dirty fingers.

DE 10 2009 058 864 B4 discloses a method for actuating a motor vehicle closure device which has a closure part which can be moved by means of a drive device, with which the mouth of a fuel filler neck can be closed, wherein by switching on an activation device, a sensor device is activated which has a proximity sensor arranged in the vicinity of the closure part, wherein the activated sensor device sends an opening signal to the drive device to open the closure part when an approaching person and/or any object approaching comes to within a predetermined distance from the proximity sensor, and that the activated sensor device emits a closing signal to the drive device for closing the closure part when the person and/or the object moves beyond the predetermined distance from the proximity sensor.

In view of the foregoing, it would be advantageous to provide a motor vehicle closure device by means of which convenient access can be realized for the person during a filling process.

### SUMMARY

One embodiment of the disclosure herein relates to a method for actuating a motor vehicle closure device of a motor vehicle. A current first position of the motor vehicle is detected by means of a position detection device of the motor vehicle. A distance between the motor vehicle and a power source for the motor vehicle for filling an energy storage device of the motor vehicle is determined. A second position of a mobile access authorization device to the motor vehicle is determined for a person by means of another position detection device of the access authorization device. Furthermore, a removal of a filling nozzle of the power source by the person is determined by means of an environment detection device of the motor vehicle. If the motor vehicle is within a predetermined first distance threshold from the power source and if the second position is within a second predetermined distance threshold from the motor vehicle closure device and if a removal of the filling nozzle is determined, then the motor vehicle closure device is actuated by means of an electronic computer device of the motor vehicle closure device.

This makes it possible to provide convenient access for the person, in particular the person carrying the mobile access authorization device.

In particular, a hands-free operation of the motor vehicle closure device can be realized. Furthermore, the position detection of the person by the mobile access authorization device can be used to recognize the filling intention, which can minimize false triggers.

By detecting the filling nozzle, for example in the form of a charging cable, the filling intention can also be validated. The filling nozzle can be either a filling nozzle of a fluidic refueling device, a charging cable of a charging station or a charging cable taken from the motor vehicle, for example for AC charging.

The mobile access authorization device can be, for example, a key element and/or key fob, a mobile terminal, in particular a mobile telephone or an intelligent telephone or a smart watch. Various “Car Connectivity” options can be provided here, for example according to the CCC (Car Connectivity Consortium) criterion. The intention to fill is then determined by the position recognition of the person via the mobile access authorization device. The position of the motor vehicle is compared to a database of known power sources, such as charging points or filling stations. The known charging points can include, for example, a fast-charging network or previous charging points of the user or motor vehicle. If the position of the person indicates that he or she is close to the motor vehicle closure device and is close to the power source by means of the comparison, it can be detected that, for example, a filling process is planned. Here, for example, a distance of two meters to the motor vehicle closure device can be realized as a second distance threshold. In the event of a false trigger despite the detection of the power source, which can be detected by the person's continued trajectory, for example, the motor vehicle closure device closes again automatically.

The motor vehicle can be a motor vehicle with an internal combustion engine or a motor vehicle with an electric drive. Furthermore, it can also be a so-called hybrid motor vehicle. In particular, the motor vehicle with the internal combustion engine has, for example, a fuel filler cap, which in the present exemplary embodiment can then be regarded as a motor vehicle closure device. The energy storage system can then be in the form of a tank. If, for example, the motor vehicle is in the form of an electric motor vehicle, the motor vehicle closure device can also be referred to as a charging cover. The energy storage system can then be in the form of an electrical energy storage device, for example of a traction battery. If, for example, the motor vehicle is in the form of a hybrid vehicle, the motor vehicle can have both a suitable fuel filler cap and a suitable charging cover as well as a suitable tank and an electrical energy storage system. In this case, it may also be provided that, for example, the position of the person in relation to the charging or the fuel filler cap is used to determine whether electric charging or fluidic charging is planned.

Furthermore, it may be provided that the fill level of the tank or the electrical energy storage system can also be taken into account. If, for example, the motor vehicle is approaching a power source, but is almost completely full, it can be assumed that no refueling process is taking place, for example. This means that the actuation of the motor vehicle closure device can be suppressed. Furthermore, it can also be checked whether, for example, the electrical energy storage system has been conditioned due to a search for or entry to a charging station, which can be used to conclude that a future charging process will take place. Preconditioning by the user, without entering a charging station, can also be taken into account.

In order to continue to include cases in which, for example, the mobile access authorization device does not approach the motor vehicle closure device, mechanical opening of the motor vehicle closure device may also be provided. In particular, comfort access to the motor vehicle closure device for the person can be realized.

In particular, provision may also be made that, for example, if the motor vehicle is locked, the motor vehicle closure device may also be locked or closed. Furthermore, before the motor vehicle closure device can be opened, authentication or verification of the user or person can also be carried out as to whether they authorized at all to carry out a corresponding filling.

As an alternative or addition to the distance thresholds, other information, such as the orientation of the motor vehicle and the type of charging point, can also be taken into account in order to open the charging flap or fuel filler flap. In addition to so-called geo-fencing, an angle of movement and/or speed of the person can also be taken into account.

In particular, in order to increase robustness for detecting a filling intention the key holder or the person who wants to start the charging process can be clearly identified. In particular, it is envisaged that the filling nozzle will now also be identified, in particular by means of an environment detection device of the motor vehicle. Here it may be provided that the filling nozzle is removed from a corresponding charging station or refueling facility as well as that the filling nozzle of a charging cable, such as an AC charging cable, is removed from the motor vehicle itself, for example from a trunk area. Only when it has also been recognized that the filling nozzle has been removed accordingly is access given to the motor vehicle closure device or is opening of the motor vehicle closure device carried out.

According to an advantageous embodiment, the environment detection device is provided as a camera and/or as a lidar sensor device. For example, the lidar sensor device can be used to generate a corresponding point cloud and reliably detect the filling nozzle, especially in the person's hand, for example. In addition, the camera can also reliably determine the filling nozzle on the basis of an object classification, for example. In particular, the camera and the lidar sensor device are already part of the motor vehicle, which means that no new components have to be installed on the motor vehicle.

Another advantageous embodiment provides that a type of the filling nozzle is identified by means of the environment detection device. In particular, a type can be understood to mean that a filling nozzle for fluidic refueling, a charging cable for DC charging or a charging cable for AC charging can be identified accordingly. Depending on this, it may then again be provided that the corresponding motor vehicle closure device is opened.

It has also been shown to be advantageous if the motor vehicle closure device is provided for a fuel filler cap of a fluidic energy storage device and/or for a charging cover of an electrical energy storage device. The fluidic energy storage system can be, for example, a gasoline tank, diesel tank or even a hydrogen tank. Thus, the motor vehicle can be equipped with both an internal combustion engine as well as with an electrical energy storage system. The combination, i.e., a hybrid vehicle, is also possible.

Furthermore, it has proven to be advantageous if a safety lock of a direct current charging device on the motor vehicle is also opened when a direct current plug is identified as a filling nozzle. In particular, the direct current charging device on the motor vehicle is also equipped with a safety lock so that no dust or moisture can penetrate. If a direct current plug, in other words a DC plug, is identified in the person's hand, the safety lock can now also be opened accordingly so that access to the direct current charging device can be reliably carried out.

It is also advantageous if a type of the power source is also identified by means of the environment detection device. For example, the power source, for example a charging station for direct current charging and/or alternating current charging or a gasoline pump for fluidic charging, can be identified accordingly. This makes it possible to identify at an early stage which type of refueling or filling is planned, and the motor vehicle closure device can be opened accordingly.

Another embodiment provides that a trajectory of the person is determined depending on the second position and the motor vehicle closure device is actuated depending on the trajectory. Thus, a direction of movement of the person can also be determined, wherein if the person moves towards the motor vehicle closure device, it is then opened accordingly.

Thus, one embodiment of the disclosure herein also concerns the fact that the motor vehicle closure device can be opened independently of the second distance threshold, for example if a trajectory is determined which leads the person towards the motor vehicle closure device.

It is also advantageous if the trajectory is also evaluated depending on a detected position of the power source. For example, a movement of the person towards the power source can be evaluated accordingly, so that it can be assumed that if the person is moving towards the power source and also a removal of the filling nozzle is detected that a filling process is to be recorded in the future. However, if, for example, the person is close to the power source but does not approach the power source, it can be assumed that the power source is not being used and that no filling process is to be recorded.

The presented method is in particular a computer-implemented method. Therefore, a further embodiment of the disclosure herein relates to a computer program product with program code means which cause an electronic computer device to carry out a method according to the previous aspect when the program code means are processed by the electronic computer device. The computer program product can also be referred to as a computer program.

Furthermore, at least one embodiment of the disclosure herein also relates to a computer-readable memory medium with the computer program product according to the previous aspect.

At least one further embodiment of the disclosure herein also relates to a motor vehicle closure device for a motor vehicle, having at least one electronic computer device, wherein the motor vehicle closure device is designed to carry out a method according to the previous aspect. In particular, the method is carried out by means of the motor vehicle closure device.

Furthermore, at least one embodiment of the disclosure herein also relates to a motor vehicle with a motor vehicle closure device according to the previous aspect. The motor vehicle may be, for example, a motor vehicle with an internal combustion engine and/or with an electronic drive device.

The electronic computer device has, for example, processors, circuits, in particular integrated circuits, as well as other electronic components in order to be able to carry out corresponding steps of the method. Electronic computer devices are commonly used in vehicles or in association with any of various vehicle operations. Electronic computer devices (which may also be referred to herein as “controllers,” “control units,” “processors” or “microprocessors”) include circuits (e.g., integrated circuits) that contain typical functionality of central processing units (CPU) and are configured to received data, perform various calculations and analysis based on manufacturer programming and/or circuit components, and send instructions to other vehicle components. Examples of controllers used in vehicles include any of various Engine Control Units (ECNs) and commonly used by different manufacturers in modern automobiles.

Advantageous embodiments of the method are to be regarded as advantageous embodiments of the motor vehicle closure device and the motor vehicle. The motor vehicle closure device as well as the motor vehicle have in particular, specific features in order to be able to carry out corresponding steps of the method.

Further features of the embodiments disclosed herein result from the claims, the FIGURE, and the description of the FIGURE. The features and combinations of features mentioned above in the description as well the as features and combinations of features mentioned below in the description of the FIGURE and/or shown in the FIGURE alone can be used not only in the respective specified combination, but also in other combinations or on their own.

### BRIEF DESCRIPTION OF THE DRAWINGS

The disclosure is now explained in more detail based on a preferred exemplary embodiment and with reference to the drawings. In the FIGURE:

FIG. 1 shows a schematic plan view of an embodiment of a motor vehicle with an embodiment of a motor vehicle closure device.

In the FIGURE, identical or functionally identical elements are provided with the same reference signs.

### DESCRIPTION

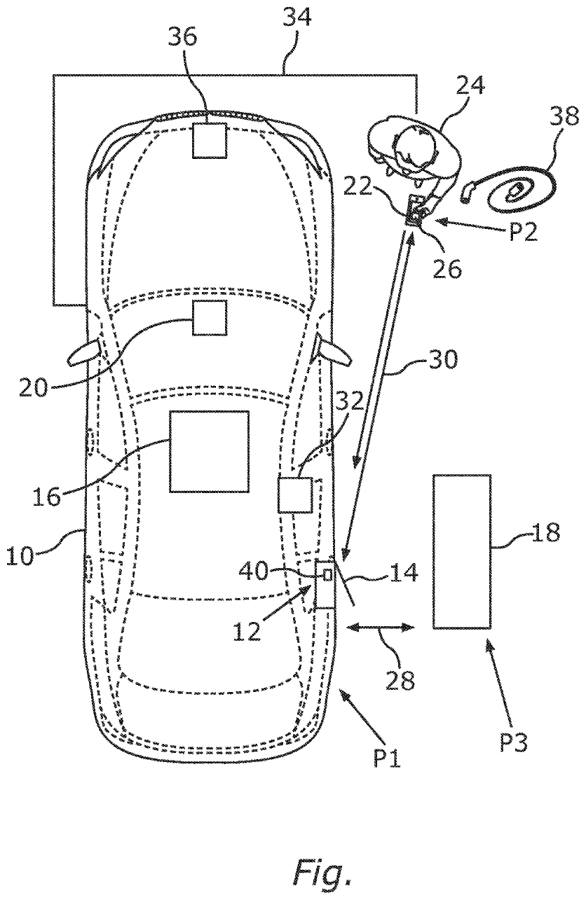

FIG. 1 shows a schematic plan view of an embodiment of a motor vehicle 10 with an embodiment of a motor vehicle closure device 12. In the present case, in particular, the motor vehicle closure device 12 (which may also be referred to herein as simply a “motor vehicle closure”) is equipped with a charging cover 14. In other words, in the present case the motor vehicle 10 is in the form in particular of an electrically powered motor vehicle 10.

The motor vehicle 10 has an energy storage device 16, in this case an electrical energy storage device 16. The electrical energy storage device 16 can be charged via the motor vehicle closure device 12 by means of a power source 18, which can be in the form of a charging station, for example. In other embodiments, the energy storage device may be another type of energy storage device, such as a gasoline tank.

With method according to the disclosure, it is envisaged that the motor vehicle closure device 12 is actuated automatically. Here a first position P1 of the motor vehicle 10 is detected by means of a position detection device 20 (which may also be referred to herein as a “position sensor”), in particular of the motor vehicle 10. A distance of the motor vehicle 10 from the power source 18 for the motor vehicle 10 for filling the energy storage device 16 of the motor vehicle 10 is determined. A second position P2 of a mobile access authorization device 22 for the motor vehicle 10 for a person 24 is determined by means of another position detection device 26 (again, which may also be referred to herein as a “position sensor”) of the access authorization device 22. The position sensors may be any of various types of position sensors known to those of ordinary skill in the art, including optical sensors, laser sensors, proximity sensors, GPS sensors, IR sensors, ultrasonic sensors, etc. If the motor vehicle 10 is within a predetermined first distance threshold 28, in particular in the so-called geofence, of the power source 18 and if the second position P2 is within a second predetermined distance threshold 30 of the motor vehicle closure device 12 and if the removal of a filling nozzle 38 for the power source 18 by the person 24 is determined by means of an environment detection device 36 of the motor vehicle 10, then the motor vehicle closure device 12 is actuated by means of an electronic computer device 32 of the motor vehicle closure device 12. In particular, the motor vehicle closure device 12 is then opened.

In particular, FIG. 1 shows that depending on the second position P2, a trajectory 34 of the person 24 is determined and that the motor vehicle closure device 12 is actuated depending on the trajectory 34.

As an alternative to the example shown in FIG. 1, it can be provided that a fuel filler cap of a fluidic energy storage device is also provided accordingly. However, as shown in FIG. 1, the charging cover 14 for the electrical energy storage device 16 is opened.

Furthermore, it may be provided that after a specified period of time after the motor vehicle closure device 12 has been actuated, an automated closing of the motor vehicle closure device 12 will be carried out. In particular, however, locking of the motor vehicle closure device 12 may be suppressed during a filling process of the energy storage device 16.

In particular, the removal of a filling nozzle 38 for the power source 18 by the person 24 is also determined by means of the environment detection device 36 (which may also be referred to herein as an “environment sensor”).

The environment detection device 36 can be provided as a camera and/or as a lidar sensor device, for example.

In addition, it may be provided in particular that a type of the filling nozzle 38 is identified by means of the environment detection device 36. In addition, it may be provided in particular that a safety lock 40 of a direct current charging device on the motor vehicle 10 is also opened in the event of an identification of a direct current plug as a filling nozzle 38. Furthermore, the type of the power source 18, for example whether it is a fluidic or electric charging station and whether the charging station is designed for alternating current and/or direct current charging, for example, can also be identified. Furthermore, the trajectory 34 can also be evaluated depending on a detected position P3 of the power source 18.

In particular, FIG. 1 thus describes that, for example, it is determined by means of geo-fencing that a charging station is located in a corresponding area around the motor vehicle 10. Furthermore, navigation to the charging station itself can also be used for preconditioning. If the person 24 now gets out, the movement of the holder is tracked by means of the recognition of the access authorization device 22. If certain criteria are met, such as a time and direction change, and the person 24 then steps into a defined area around the motor vehicle closure device 12, it opens. For example, computer vision on the camera or the lidar point clouds of the environment detection device 36 can be used to clearly identify the person 24 who wants to start the charging process in order to increase the robustness of the access authorization device 22 or rather the person 24.

Depending on the performance of the computer vision, a charging cable in their hand can be identified in particular by means of machine learning algorithms to increase confidence even further.

This is followed in particular by the detection of whether the charging infrastructure is in the immediate vicinity of the parking position. This algorithm is only called up if, for example, a charging infrastructure is reported via Geo-Fencing in order to increase efficiency. In addition, the charging type, for example AC or DC charging, is also detected, as the so-called DC cover, in other words a safety lock 40, must also be opened automatically, especially during DC charging. In some circumstances, this may not only be due to geo-fencing, as both AC and DC charging can be available at one charging stand. Furthermore, the intention to charge is detected by detecting a charging plug, for example, wherein the motor vehicle closure device 12 is not opened if the charging plug is not detected. Furthermore, the approximate position of the power source 18 relative to the motor vehicle 10 can also be determined, so that corresponding trajectories 34 can be better classified. In addition, the camera can still be used for scenarios that have a poor GPS signal, for example in underground car parks, or have not stored a charging station in the geo-fencing, for example in the case of a private household.

### LIST OF REFERENCE SIGNS

10 Motor vehicle
12 Motor vehicle closure device
14 Charging cover
16 Energy storage device
18 Power source
20 Position detection device
22 Mobile access authorization device
24 Person
26 Further position detection device
28 First distance threshold
30 Second distance threshold
32 Electronic computer device
34 Trajectory
36 Detection device
38 Digital map
38 Filling nozzle
40 Safety lock
P1 First position
P2 Second position
P3 Position

1.-10. (canceled)

11. A method for actuating a motor vehicle closure of a motor vehicle, the method comprising:
detecting a current first position of the motor vehicle with a position sensor of the motor vehicle;
determining a distance of the motor vehicle from a power source for the motor vehicle for filling an energy storage device of the motor vehicle;
determining a second position of a mobile access authorization device from the motor vehicle for a person with a further position detection sensor of the access authorization device;
determining a withdrawal of a filling nozzle for the power source by the person with an environment sensor of the motor vehicle; and
when the motor vehicle is within a predetermined first distance threshold from the power source and when the second position is within a second predetermined distance threshold from the motor vehicle closure and when a removal of the filling nozzle is determined, then actuating the motor vehicle closure with an electronic computer of the motor vehicle closure.

12. The method as claimed in claim 11, wherein the environment sensor is provided as a camera and/or as a lidar sensor device.

13. The method as claimed in claim 12, wherein a type of the filling nozzle is identified by the environment sensor.

14. The method as claimed in claim 13, wherein the motor vehicle closure is provided for a filler cap of a fluidic energy storage device and/or for a charging cover of an electrical energy storage device.

15. The method as claimed in claim 14, wherein a safety lock of a direct current charging device on the motor vehicle is opened when a direct current plug is identified as the filling nozzle.

16. The method as claimed in claim 15, wherein a type of the power source is identified by the environment sensor.

17. The method as claimed in claim 16, wherein depending on the second position a trajectory of the person is determined, and depending on the trajectory the motor vehicle closure is actuated.

18. The method as claimed in claim 17, wherein depending on a detected position of the power source, the trajectory is evaluated.

19. A non-transitory computer-readable medium for actuating a motor vehicle closure, wherein the computer-readable medium comprises instructions which, when executed on a controller cause the controller to:
detect a current first position of the motor vehicle with a position sensor of the motor vehicle;
determine a distance of the motor vehicle from a power source for the motor vehicle for filling an energy storage device of the motor vehicle;
determine a second position of a mobile access authorization device from the motor vehicle for a person with a further position sensor of the access authorization device;
determine a withdrawal of a filling nozzle for the power source by the person with an environment sensor of the motor vehicle; and
when the motor vehicle is within a predetermined first distance threshold from the power source and when the second position is within a second predetermined distance threshold from the motor vehicle closure and when a removal of the filling nozzle is determined, then electronically actuating the motor vehicle closure.

20. The non-transitory computer-readable medium of claim 19, wherein the environment sensor is provided as a camera and/or as a lidar sensor device.

21. The non-transitory computer-readable medium of claim 19, wherein a type of the filling nozzle is identified by the environment sensor.

22. The non-transitory computer-readable medium of claim 21, wherein the motor vehicle closure is provided for a filler cap of a fluidic energy storage device and/or for a charging cover of an electrical energy storage device.

23. The non-transitory computer-readable medium of claim 22, wherein a safety lock of a direct current charging device on the motor vehicle is opened when a direct current plug is identified as the filling nozzle.

24. The non-transitory computer-readable medium of claim 19, wherein a type of the power source is identified by the environment sensor.

25. The non-transitory computer-readable medium of claim 19, wherein depending on the second position, the instructions further cause the controller to determine a trajectory of the person and, depending on the trajectory, actuate the motor vehicle closure.

26. The non-transitory computer-readable medium of claim 25, wherein depending on a detected position of the power source, the instructions further cause the controller to evaluate the trajectory.

27. A motor vehicle closure device for a motor vehicle, the motor vehicle closure device comprising:
a first position sensor configured to detect a current first position of the motor vehicle and determine a distance of the motor vehicle from a power source for the motor vehicle for filling an energy storage device of the motor vehicle;
a second position sensor configured to determine a second position of a mobile access authorization device and an associated person from the motor vehicle;
an environment sensor configured to determine a withdrawal of a filling nozzle for the power source by the person; and
an electronic actuator configured to actuate the motor vehicle closure when the motor vehicle is within a predetermined first distance threshold from the power source and when the second position is within a second predetermined distance threshold from the motor vehicle closure device and when a removal of the filling nozzle is determined.

28. The motor vehicle closure device of claim 27 wherein the environment sensor is provided as a camera and/or as a lidar sensor device.

29. The motor vehicle closure device of claim 27 wherein the motor vehicle closure device is provided in association with a filler cap of a fluidic energy storage device and/or in association with a charging cover of an electrical energy storage device.

30. The motor vehicle closure device of claim 27 further comprising a controller configured to deliver instructions to the motor vehicle actuator, the controller configured to determine a trajectory of the person depending on the second position, and depending on the trajectory, actuate the motor vehicle closure.
